(19) United States
(12) Patent Application Publication
(10) Pub. No.: US 2014/0272783 A1
(43) Pub. Date: Sep. 18, 2014

(54) SUCTION SYSTEM AND METHODS OF MAKING AND USING SAME

(71) Applicants: Gerald E. Kelley, Oklahoma City, OK (US); Gerald E. Kelley, (US)

(72) Inventor: William Harris, Oklahoma City, OK (US)

(21) Appl. No.: 13/801,745

(22) Filed: Mar. 13, 2013

(51) Int. Cl. A61C 17/06

(52) U.S. Cl. CPC A61C 17/04
USPC 433/95; 433/215

(57) ABSTRACT

A suction system for removing fluid from an individual. The suction system has a container assembly, a suction tube, an output hose and a suction valve assembly. The container assembly is connectable to an air source and a container is configured to receive the fluid from the individual. The suction tube is connectable to the container assembly and in fluid communication with the air source. The output hose is connectable to the container assembly and in fluid communication with the container. The suction valve assembly has a housing and a pin. The pin is movable between an open and closed position so that fluid is removable from the individual.

### CROSS REFERENCE TO RELATED APPLICATIONS

Not applicable.

### BACKGROUND

Suction systems are used in office and hospital environments and particularly during various dental and surgical procedures to drain bodily fluid from a patient. In general, suction systems employ a collection system and a vacuum source which enables bodily fluid to be drained from the patient.

Suction systems are used in medical and dental treatment. Suction systems used in the treatment of the body of an individual are well known in the art. Typically, such suction devices cost large sums of money and are heavy, stationary devices.

### SUMMARY

Various embodiments disclosed herein relate generally to suction devices, and more particularly, not by way of limitation, to an improved suction system used in the treatment of an individual. Various embodiments disclosed herein relate to a suction system for use in combination with an air source to suction fluid from the body of an individual during dental or medical procedures. The suction system is connected to an air source. Air travels through a connector to an air inlet tube of a suction container assembly. The air travels through a second connector to the suction valve assembly. When in use, a button is pressed on the suction valve which moves a plunger assembly to an open position and lets air out of the second connector providing the suction to remove fluid from the body of an individual through a fluid outlet port. The fluid travels through an output hose to a waste container. The waste container is easily removable when full.

In various embodiments, a suction system includes a container assembly, a suction tube, an output hose and a suction valve assembly. The container assembly is connectable to an air source. The container assembly has a container wherein a portion of the container is configured for receiving a fluid from an individual. The container assembly has at least one connector, a portion of the at least one connector receiving air from the air source. The at least one connector of the container assembly receives a fluid from the individual. The container is in fluid communication with the at least one connector. The container assembly has a housing having at least one opening in fluid communication with the suction tube. The container assembly has a housing having at least one opening in fluid communication with the output hose. The suction tube is connectable to the container assembly wherein the suction tube is in fluid communication with the air source. The suction tube is connectable to a portion of the suction valve assembly. The output hose is connectable to the container assembly wherein the output hose is in fluid communication with the container. The output hose is connectable to a portion of the suction valve assembly. The suction valve assembly has a housing and a pin. The housing of the suction valve assembly has a first portion and a second portion such that the second portion of the housing has a diameter smaller than that of the first portion. The housing of the suction valve assembly has a valve seat defined by a internal shoulder positioned in a passageway of the housing. The housing has an air inlet port, a suction inlet port and a fluid outlet port such that the air inlet port is in fluid communication with the suction tube and the fluid outlet port is in fluid communication with the output hose. The pin is movable between a closed position and an open position. In the closed position, the pin is moved to prevent fluid communication between the air inlet port and the suction inlet port. In the open position, the pin is moved to allow fluid communication between the air inlet port, the suction inlet port and the fluid outlet port so that fluid is removed from the individual. The pin has at least one angular groove wherein the at least one angular groove is moved against the valve seat when the pin is in the closed position and wherein the at least one angular groove is moved off the valve seat when the pin is in the open position.

In another embodiment, the suction system has an attachment assembly. The attachment assembly has a body portion for connecting the container assembly to the air source. The attachment assembly is provided with a connector for connecting a portion of the suction system to a support structure. The connector is substantially U-shaped.

In one embodiment, a suction valve assembly includes a housing and a pin. The housing has an air inlet port, a suction inlet port and a fluid outlet port such that the air inlet port is in fluid communication with the suction tube and the fluid outlet port is in fluid communication with the output hose. The housing of the suction valve assembly has a valve seat defined by an internal shoulder positioned in a passageway of the housing. The pin is movable between a closed position and an open position in the housing. In the closed position, the pin is moved to prevent fluid communication between the air inlet port and the suction inlet port. In the open position, the pin is moved to allow fluid communication between the air inlet port, the suction inlet port and the fluid outlet port so that fluid is removed from the individual. The pin has at least one angular groove wherein the at least one angular groove is moved against the valve seat when the pin is in the closed position and wherein the at least one angular groove is moved off the valve seat when the pin is in the open position. A portion of the pin is provided with a button.

When removing a fluid from an individual, a portion of the suction valve assembly is positioned in an opening, such as the mouth, of the individual. The pin of the suction valve assembly is moved to prevent fluid communication between the air inlet port and the suction inlet port of the suction valve assembly. To remove the fluid, the pin is moved to allow fluid communication between the air inlet port the suction inlet port and a fluid outlet port of the suction valve assembly.

To this end, although suction systems of the existing art are operable, further improvements are desirable to provide a more cost-effective, portable system which enhances the use of a suction system. These and other features and advantages which may characterize various embodiments can be understood in view of the following detailed discussion and the accompanying drawings.

### BRIEF DESCRIPTION OF THE DRAWINGS

FIG. 1 is a perspective view of a suction system constructed in accordance with the present disclosure.

FIG. 2 is a perspective view of an attachment assembly of the suction system of FIG. 1.

FIG. 3 is an exploded perspective view of a suction container assembly of the suction system of FIG. 1.

FIG. 4 is a cross sectional view of a housing of the suction container assembly of FIG. 3.

FIG. 5 is a top plan view of a connector of the suction container assembly of FIG. 3.

FIG. 6 is an exploded perspective view of a suction valve assembly of the suction system of FIG. 1.

FIG. 7 is a plan view of a housing of the suction valve assembly of FIG. 6.

FIG. 8 is a cross-sectional view of the housing of FIG. 7.

### DETAILED DESCRIPTION

Referring now to the drawings, and more particularly to FIGS. 1 and 2, shown therein is at least one embodiment of a suction system 10. The suction system 10 is used to remove fluid from the body of an individual during treatment. The suction system 10 is portable and may be utilized for a variety of purposes such as dental, medical, veterinary, emergency (ambulatory), or the like. The suction system 10 is preferably made of a durable, lightweight and rigid material which is strong enough to withstand high pressure. Suitable materials for construction of the suction system and components thereof include metals such as aluminum, steel, titanium, magnesium or alloys containing these metals, plastics, polymeric materials, and composite materials which are capable of providing the desired strength and durability for the suction system 10. All parts of the suction system 10 may be autoclavable. Additionally, the suction system 10 may be sized and dimensioned in various sizes to fit the mouths of both adults and children. It is contemplated, in at least one embodiment, that the suction system 10 is constructed from multiple pieces of material and as various components. However, it should be understood, in at least one embodiment, that portions of the suction system 10 may be constructed from one solid piece of material or as one component rather than various components.

Broadly, the suction system 10 includes an attachment assembly 12, a container assembly 14, a suction tube 16, an output hose 18, and a suction valve assembly 20. The attachment assembly 12 includes a body portion 22 and a pair of connector members 24 and 26. The body portion 22 of the attachment assembly 12 has a first end 28 and a second end 30. The body portion 22 is configured to be connected to an air source 31 so as to deliver air to the suction system 10. It should be understood by one of ordinary skill in the art that any conventional air source used to provide air to a suction system may be utilized along with the suction system 10 so long as the air source 31 functions in accordance with the present disclosure as described herein. The body portion 22 is provided with a nipple 32 and a connector 34 positioned between the first end 28 and the second end 30 of the body portion 22 of the attachment assembly 12. The connector 34 is shown as a female quick disconnect for connecting the suction valve assembly 20 to the attachment assembly 12. However, it should be understood by one of ordinary skill in the art that any connector or means for connecting one element to another may be utilized so long as the connector functions in accordance with the present disclosure as described herein. The nipple 32 and the connector 34 are positioned substantially perpendicular to one another and are in fluid communication. The air source 31 is removably connected to the attachment assembly 12 at the nipple 32. It should be understood by one of ordinary skill in the art that the various elements of the attachment assembly 12 may be configured in various ways so long as the attachment assembly 12 functions in accordance with the present disclosure as described herein.

The connector member 24, having an opening 40, extends from the first end 28 of the body portion 22. The connector member 26, having an opening 42, extends from the second end 30 of the body portion 22 so as to be aligned with the connector member 24. It should be understood that although the openings 40 and 42 are shown as circular, any known shape opening may be used, such as square, hexagonal, triangular, rectangle, symmetrical, asymmetrical and the like, so long as the openings 40 and 42 function in accordance with the present disclosure. A screw (not shown) is used to connect each of the connector members 24 and 26 and thus the attachment assembly 12 to any known structure, such as a table, cabinet, wall or the like. It should be understood that connectors, such as, for example, a screw, and methods of connecting one object to another are well known to one of ordinary skill in the art.

Optionally, in at least one embodiment, in order to mount the attachment assembly 12 of the suction system 10 to a supporting structure 44, such as a post, pole or the like, the suction system 10 further includes a U-shaped connector 50. The U-shaped connector 50 has a first arm 52 and a second arm 54 provided with a U-shaped configuration. It should be understood that although a U-shaped configuration is provided, any such shaped configuration may be provided such as V-shaped, C-shaped, or the like so long as the connector functions in accordance with the present disclosure as described herein. The U-shaped connector 50 has a first end 56 and a second end 58, each end which is externally threaded. The first and second arms 52 and 54 are provided with a sufficient length to be positioned about a supporting structure and through the openings 40 and 42 of the connector members 24 and 26, respectively, to connect the attachment assembly 12 with conventional nuts to the supporting structure and to enhance stability of the connection of the attachment assembly 12 of the suction system 10 to a supporting structure, such as a post, pole or the like.

Referring to FIGS. 1,3-5, in at least one embodiment, the container assembly 14 includes a housing 60, a first connector 62, a second connector 64, a third connector 66, a barrel 68 and a container 69. It should be understood by one of ordinary skill in the art that various elements of the container assembly 14 may be configured in various ways, as multiple components or as a single component, so long as a portion of the container assembly 14 connects to the attachment assembly 12 and functions in accordance with the present disclosure as described herein. In another embodiment, the container assembly 14 is configured to be connected to the air source 31 in various other ways, such as, without the attachment assembly 12, so long as the container assembly 14 functions in accordance with the present disclosure as described herein.

The housing 60 is shown as a female three way connector having a chamber 70, a first opening 72 which is internally threaded, a second opening 74, a third opening 76 and an extension member 78 which is externally threaded. The chamber 70 includes a seat 80 which is defined by an internal shoulder positioned in the chamber 70 of the housing 60. The seat 80 and an edge 82 of the second opening 74 are positioned a distance from one another so as to create a retaining space 84. The retaining space 84 is configured to receive the barb fitting 66. The extension member 78 is positioned through the container 69 for receiving a fluid from the mouth of an individual. It should be understood that although the container 69 is shown being utilized herein as a bottle, any type of container for catching and/or storing fluid may be used.

The first connector 62 includes an engaging portion 90 and a threaded portion 92. The engaging portion 90 of the first connector 62 mates with the connector 34 of the attachment assembly 12 for removably connecting the container assembly 14 to the attachment assembly 12. The second connector 64, shown as a male quick disconnect, is formed integrally with (e.g. permanently bonded or soldered) or as one-piece (e.g. molded together) with the first connector 62 at an end 94 of the threaded portion 92. The second connector 64 allows air to travel to the suction tube 16 and is positioned to extend through the second opening 74 of the housing 60 such that an end 96 extends out away from the housing 60. The threaded portion 92 of the first connector 62 threadingly engages the threaded portion of the first opening 72 which seals the first opening 72 thereby preventing fluid flowing from the chamber 70 and such that the second opening 74 is in fluid communication with the third opening 76.

The barrel 68 is desirably cylindrically shaped and has a proximal end 100, a distal end 102, and a passageway 104 extending longitudinally through the barrel 68 from the proximal end 100 to the distal end 102. The barrel 68 has a wall 106 defining the passageway 104. The proximal end 100 of the container 69 is internally threaded. The proximal end 100 of the barrel 68 is positioned in the container 69. The proximal end 100 threadingly engages the extension member 78 to create a tight seal between a lower end 108 of the housing 60 and the proximal end 100 of the barrel 68 and thereby prevent fluid from flowing from the barrel 68 and the housing 60.

The suction tube 16 has a first end 110 and a second end 112. The first end 110 of the suction tube 16 is connected to the end 96 of the second connector 64 for receiving the air from the air source 31. The first end 110 of the suction tube 16 may be fixed to the end 96 of the second connector 64 with a tie, a clamp, bonding material, a clip, or any such method known in the art for connecting one object to another so long as it functions in accordance with the present disclosure. The first and second ends 110 and 112 are sealed so that no fluid from the mouth is capable of passing into the suction tube 16.

The output hose 18 has a first end 114 and a second end 116. The first end 114 of the output hose 18 is connected to the third connector 66 so that fluid removed from the mouth of an individual flows into the housing 60 through the second opening 74 which is in fluid communication with the third opening 76, thus sending the fluid into the container 69. The suction tube 16 passes within the output hose 18 extending between the first and second ends 114 and 116 of the output hose 18 so that the suction tube 16 and the output hose 18 may be positioned and moved in the same direction.

Referring now to FIGS. 6-8, the suction valve assembly 20 includes a housing 120, a spray bar 122 and a plunger assembly 124. The housing 120 has a proximal end 126, a distal end 128 and a wall 130. An outer portion 125 of the wall 130 defines an outer shoulder 127 positioned between the proximal end 126 and the distal end 128 of the housing 120 to provide the housing 120 with a first portion 129 and a second portion 131. The second portion 131 of the housing 120 has a diameter smaller than that of the first portion 129 of the housing 120 so that the output hose 18 may be connected to the second portion 131 of the housing 120.

The wall 130 defines a chamber 132 which has a first end 134 and a second end 136. The wall 130 includes an air inlet port 138, a suction inlet port 140, and a fluid outlet port 142 and an opening 144. The air inlet port 138 is configured with a barb 145 so as to receive the second end 112 of the suction tube 16 to provide air to the housing 120. Proximate the suction inlet port 140 is an angular groove 147 for receiving a seal member such as an o-ring 146, to effect a fluid tight seal between the suction inlet port 140 and the chamber 132 of the housing 120. The fluid outlet port 142 tapers away from the first end 134 of the chamber 132 toward the proximal end 126 of the housing 120. The tapering of the fluid outlet port 142 has the effect of increasing the pressure of the vacuum. The opening 144 is configured to receive the spray bar 122 and a portion of the plunger assembly 124.

The spray bar 122 has a proximal end 150, a distal end 152, and a wall 154. The wall 154 defines a passageway 156 extending between the proximal and distal ends 150 and 152. A valve seat 158 is defined by an internal shoulder positioned in the passageway 156 of the spray bar 122. The valve seat 158 is positioned between the proximal end 150 and the distal end 152. The valve seat 158 desirably faces the proximal end 150 of the spray bar 122 so as to provide the passageway 156 with a first portion 160 and a second portion 162. The first portion 160 of the passageway 156 of the spray bar 122 has a diameter greater than that of the second portion 162 of the passageway 156 of the spray bar 122 to form the valve seat 158. An opening 164 is formed in the sidewall 155 in the first portion 160 of the passageway 156 and an opening 166 is formed in the sidewall 155 in the second portion 162 of the passageway 156 near the distal end 152 of the spray bar 122. The opening 164 is positioned in the air inlet port 138 so as to be in fluid communication with the air inlet port 138. In one embodiment, the various elements of the spray bar 122 are defined as a part of the housing 120.

The plunger assembly 124 has a button 170, a pin 172 and a biasing member 174. The button 170 includes a rim 175 extending about a bottom edge 176 of the button 170. The pin 172 has a proximal end 178 connected to the button 170 and a distal end 180. Further, the pin 172 includes a first angular groove 182 and a second angular groove 184 formed between the proximal and distal ends 178 and 180 of the pin 172. The first and second angular grooves 182 and 184 are configured for receiving a seal member such as an o-ring 186. The pin 172 of the plunger assembly 124 is positioned in the passageway 156 of the spray bar 122. The first and second angular grooves 182 and 184 with the o-rings 186 effect a fluid tight seal with the valve seat 158 when moved between an open position and a closed position. Further, a screw 192 is provided in the outer portion 125 of the wall 130 of the housing 120 proximate the opening 144 to keep the plunger assembly 124 stabilized in the passageway 158 of the spray bar 122.

The biasing member 174 is shown by way of example as a spring, but could be any device or assembly for biasing the second angular groove 184 having the o-ring 186 against the valve seat 158. For example, a ferrous metal such as steel or iron may be utilized in a portion of the pin 172, and a magnet can be incorporated into the valve seat 158. The biasing member 174 is positioned in the spray bar 122 at the proximal end 150.

In at least one embodiment, the suction valve assembly 20 is moved between a closed position and an open position. In the closed position, the biasing member 174 biases the second angular groove 184 having the o-ring 186 against the valve seat 158, preventing fluid (in this example, air) communication of the air inlet port 138 with the opening 164 of the spray bar 122. In the open position, the button 170 is manually depressed to move the second angular groove 184 having the o-ring 186 off of the valve seat 158, thus allowing fluid communication between the air inlet port 138 and the opening 164 of the spray bar 122.

In another embodiment, an adapter (not shown) may be provided to the distal end 128 of the housing 120 of the suction valve assembly 20. One end of the adapter fits into the suction inlet port 140. Another end of the adapter is configured for receiving an extension tube (not shown) for allowing easier accessibility to the back of an individual's mouth.

Referring to FIGS. 1-8, in use, the suction system 10 is connected to an air source 31. Air travels from the air source 31 through the connector 34 to the second connector 64 of the container assembly 14. The air travels through the second connector 64 of the container assembly 14 which is in fluid communication with the suction tube 16. When the button 170 on the suction valve assembly 20 is pressed by an individual, the plunger assembly 124 moves to the open position and lets air out of the air inlet port 138 providing the necessary suction from the suction tube 16 to remove fluid from the body of an individual through the fluid outlet port 142. The fluid travels through the output hose 18 to the container 69. The container 69 is easily removable from the suction system 10 when full.

It is to be understood that even though numerous characteristics and advantages of various embodiments of the present invention have been set forth in the foregoing description as well as those inherent in the invention, together with details of the structure and function of various embodiments of the invention, this detailed description is illustrative only, and changes may be made in detail, especially in matters of structure, combinations, operations, and arrangements of parts within the principles of the present invention to the full extent indicated by the broad general meaning of the terms in which the appended claims are expressed.

What is claimed is:

1. A suction system, comprising:
a container assembly connectable to an air source, the container assembly having a container wherein a portion of the container is configured for receiving a fluid from an individual;
a suction tube connectable to the container assembly wherein the suction tube is in fluid communication with the air source;
an output hose connectable to the container assembly wherein the output hose is in fluid communication with the container; and
a suction valve assembly having a housing and a pin, the housing having an air inlet port, a suction inlet port and a fluid outlet port such that the air inlet port is in fluid communication with the suction tube and the fluid outlet port is in fluid communication with the output hose, the pin movable between a closed position and an open position, in the closed position, the pin is moved to prevent fluid communication between the air inlet port and the suction inlet port and in the open position, the pin is moved to allow fluid communication between the air inlet port, the suction inlet port and the fluid outlet port so that fluid is removed from the individual.

2. The suction system of claim 1 wherein the container assembly has at least one connector, a portion of the at least one connector receiving air from the air source.

3. The suction system of claim 2 wherein the at least one connector of the container assembly receives a fluid from the individual.

4. The suction system of claim 2 wherein the container is in fluid communication with the at least one connector.

5. The suction system of claim 1 wherein the container assembly has a housing having at least one opening in fluid communication with the suction tube.

6. The suction system of claim 1 wherein the container assembly has a housing having at least one opening in fluid communication with the output hose.

7. The suction system of claim 1 wherein the suction tube is connectable to a portion of the suction valve assembly.

8. The suction system of claim 1 wherein the output hose is connectable to a portion of the suction valve assembly.

9. The suction system of claim 1 wherein the housing of the suction valve assembly has a first portion and a second portion such that the second portion of the housing of the suction valve assembly has a diameter smaller than that of the first portion.

10. The suction system of claim 1 wherein the housing of the suction valve assembly has a valve seat defined by a internal shoulder positioned in a passageway of the housing.

11. The suction system of claim 10 wherein the pin has at least one angular groove wherein the at least one angular groove is moved against the valve seat when the pin is in the closed position and wherein the at least one angular groove is moved off the valve seat when the pin is in the open position.

12. The suction system of claim 1 further comprising:
an attachment assembly having a body portion for connecting the container assembly to the air source.

13. The suction system of claim 12 wherein the attachment assembly is provided with a connector for connecting a portion of the suction system to a support structure.

14. The suction system of claim 13 wherein the connector is substantially U-shaped.

15. A suction valve assembly, comprising:
a housing the housing having an air inlet port, a suction inlet port and a fluid outlet port such that the air inlet port is in fluid communication with the suction tube and the fluid outlet port is in fluid communication with the output hose, and
a pin movable between a closed position and an open position in the housing, in the closed position, the pin is moved to prevent fluid communication between the air inlet port and the suction inlet port and in the open position, the pin is moved to allow fluid communication between the air inlet port, the suction inlet port and the fluid outlet port so that fluid is removed from the individual.

16. The suction valve assembly of claim 15 wherein the housing of the suction valve assembly has a valve seat defined by an internal shoulder positioned in a passageway of the housing.

17. The suction valve assembly of claim 15 wherein the pin has at least one angular groove wherein the at least one angular groove is moved against the valve seat when the pin is in the closed position and wherein the at least one angular groove is moved off the valve seat when the pin is in the open position.

18. The suction valve of claim 15 wherein a portion of the pin is provided with a button.

19. A method for removing a fluid from an individual, comprising:
moving a pin of a suction valve assembly to prevent fluid communication between an air inlet port and a suction inlet port of the suction valve assembly; and
moving the pin to allow fluid communication between the air inlet port the suction inlet port and a fluid outlet port of the suction valve assembly.

20. The method of claim 19, further comprising:
positioning the suction valve assembly in an opening of the individual.
